(19) United States
(12) Patent Application Publication
(10) Pub. No.: US 2005/0177272 A1
(43) Pub. Date: Aug. 11, 2005

(54) Controlling device for monitoring the spatial or mechanical delimitation of producer goods or materials in the production cycle by using of transponder technology

(76) Inventor: Harald Buchmann, BINDLACH (DE)

Correspondence Address: Leopold Presser;Scully Scott Murphy & Presser, 400 Garden City Plaza, Suite 300, Garden City, NY, 11530, US

(21) Appl. No.: 10/509,664

(22) PCT Filed: Apr. 25, 2003
(86) PCT No.: PCT/EP03/04328

(30) Foreign Application Priority Data
Apr. 25, 2002 (DE) 102 18 624.3
Jan. 14, 2003 (DE) 103 01 076.9

(51) Int. Cl. G07C 9/00

(52) U.S. Cl. 700/225; 340/5.61; 340/10.1; 340/571; 700/230

(57) ABSTRACT

The invention relates to a method for monitoring access in manufacturing plants that comprises the following steps: defining access-controlled areas in a manufacturing plant into which defined objects should not enter; applying a transponder to a container, whereby the transponder carries an item of information regarding the contents of the container; providing base stations in the access-controlled areas and using the base stations to detect when a container approaches an access-controlled area into which the contents of the container should not enter, and; indicating the prohibited approach of a container. The invention also relates to a device for carrying out this method.

The present invention relates to a method and a device for position control in factories using transponders. The invention relates furthermore to the use of transponders for such position control in factories.

There should thereby be understood by position control that it is intended to be detected and if necessary indicated that defined objects are located in areas of the factory or are approaching those areas in which they should not enter because of the prevailing conditions.

A preferred application case is thereby the semiconductor industry in which often a difference is made between copper and non-copper processes. During manufacture, it must therefore be ensured that for example no FOUPs (Front-Opening-Unified-Pod), i.e. a combination for example of a 300 mm wafer cassette with a transport carrier with a security front door, passes from the copper area (copper-manufacturing line) into the area of non-copper-processes, since otherwise contamination of the non-copper-manufacturing line would be a threat. Correspondingly, the present invention is set the object of providing a technology which enables position control of objects in factories. In particular, the invention is intended to make it possible that leaving the copper area and the possible approach of a copper-FOUP towards a non-copper-plant or vice versa can be detected and indicated.

This object is achieved according to the invention by the features of the independent claim, which relates to a method for position control in factories, a corresponding device and the use of transponders for such a method.

The sub-claims concern particularly advantageous developments of the central concept of the invention.

According to the invention, a method for position control in factories is therefore provided, access-controlled areas of a factory being defined in advance, defined objects not being intended to enter into these access-controlled areas. Alternatively, also the exit of a container from an access-controlled area can be monitored.

Transponders are attached to containers, the transponders carrying information with respect to the contents of the respective container. Furthermore, at least one base station is fitted in the factory in the access-controlled areas. Then it is detected and indicated if a container is approaching an access-controlled area into which the contents of the container characterised by an identification of the transponder is not intended to enter according to the prior definition.

The access-controlled area can be in particular a machine or a manufacturing line to which containers with the correct objects are intended to be supplied.

The method can thereby have the step of detecting an identification signal of a base station by means of a transponder attached to a container. On the basis of the identification signal, the transponder can then detect that the associated container is approaching a non-permitted area. This non-permitted approach can then be indicated directly on the container, for example on a FOUP. These indications can be effected acoustically and/or optically.

Alternatively and/or additionally, an activation signal of a base station can be detected by a transponder attached to a container. Thereupon, the activated transponder transmits an identification to the base station. Thereupon, the base station can emit an acoustic and/or optical warning signal, if the identification of the activated transponder indicates a non-permitted container for the area associated with the base station.

Further aspects relate to a device which is suitable for implementing methods of this type and also the use of transponders for the position control of containers and objects in factories.

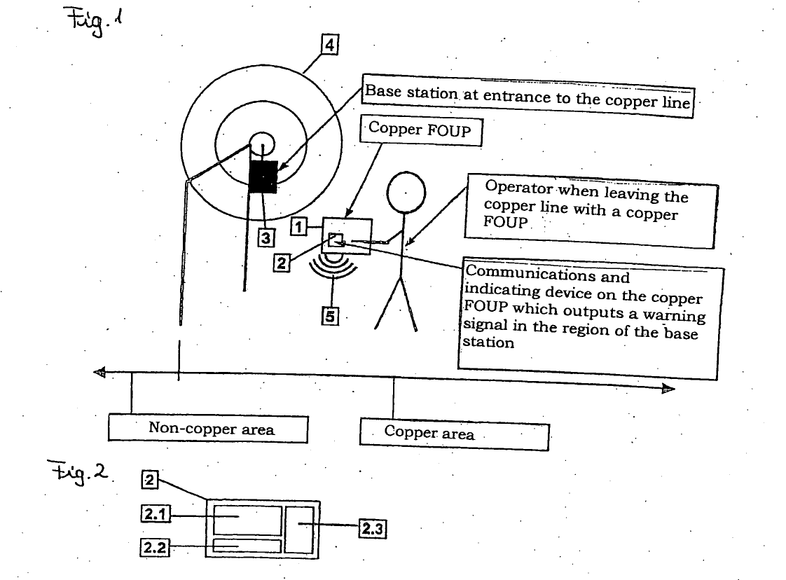

Further features, properties and advantages are now explained in more detail with reference to FIGS. 1 and 2 of the annexed drawings by means of preferred embodiments.

FIG. 1 shows schematically a device for position control in factories according to the present invention.

FIG. 2 shows the -communications and indication device with its components.

As is evident in the Figure, an active and/or passive transponder 2.2, which can if necessary itself transmit identification signals 5 or the like, can be attached to an object or a container, in particular a FOUP (Front-Opening-Unified-Pod). There should be understood by FOUP the combination of a 300 mm wafer cassette with a transport carrier, which has a sealed front door which can have a portable mini-environment.

Containers and/or objects 1 of this type can be transported either manually, as illustrated in the Figure, or in an automated manner in a factory with manufacturing lines and/or machines. The communications and indication device 2 attached to the container and/or object 1 makes possible, by means of the integrated transponder 2.2, identification of the objects contained in the container 1 or the objects themselves if the communications and indication device 2 is attached directly to them.

A further element of the invention is a base station with reading/transmitting function 3, the transmission (scanning) being designated schematically with 4. The base station can be connected to a network of base stations, which network can be connected to a control computer in order to ensure blanket monitoring.

With such a device, for example the approach of a FOUP from the copper area i.e. of a FOUP which carries copper-containing objects, to a non-copper-machine or non-copper-manufacturing plant, can be directly signalled on the FOUP optically and/or acoustically. For this purpose, a special warning device can be attached to the FOUP which is equipped for example with an active transponder. At the limits of defined areas of the copper-line or at the plant/machines of the non-copper-line itself, special base stations 3 are provided, which permanently detect (scan) the access area for non-permitted FOUPs, such as for example FOUPs from the copper area. If a non-permitted FOUP comes into the access area defined by the reception range of the base station 4 and is “scanned”, the communications and indication device 2 on the FOUP detects this and can output a warning signal or an indication for the operator on the integrated display 2.1.

Alternatively or additionally, an active transponder in the communications and indication device 2, after scanning, i.e. after the reception and hence activation of a signal from the base station 3, can transmit back its data, in particular identification data, to the base station 3 so that the latter can itself output a warning signal or else can trigger a warning signal via a data line.

The method can of course be applied correspondingly during the approach of a FOUP from the copper area to a non-copper plant.

The transponder of the communications and indication device 2 on the FOUP 1 can therefore be configured for carrying out the following functions:
if the transponder 2.2. is scanned, it transmits back its data (identification data) to the base station 3 independently,
the base station 3, by means of the identification data of the transponder, detects which particular FOUP is concerned and can hence, dependent upon the detected FOUP type, initiate corresponding measures or further process or relay the identification data received from the transponder,
by means of the received signal strength during transmission coming from the transponder, the base station 3 can estimate the distance of the FOUP 1 from the base station 3. Correspondingly, it can adopt measures, such as for example comments, warnings and alarms or barriers which depend upon the distance, detected by means of the signal strength, between the FOUP 1 and the base station 3,
the base station 3 can transmit data to the FOUP 1 in order to implement actualisation/update of the transponder on the FOUP,
the data of the transponder can alternatively be read out on the container 1 itself and be further processed,
the data of the transponder, i.e. the identification data stored in it, can alternatively be indicated by means of an LCD display 2.1 directly on the FOUP 1,
alternatively, the identification data in the transponder can be read-out by the operator by means of a special mobile reader which, by means of secure identification, assists handling by the user,
it can be provided that, for the bidirectional transmission from the base station 3 to the transponder 2.2 or vice versa, different frequencies or frequency bands are provided. Preferably, the data transmission is thereby effected from the transponder 2.2 back to the base station by means of a higher frequency than the reverse transmission since this makes a greater range possible. For the data transmission from transponder back to the base station, in particular UHF is possible,
the transponder 2.2 can be fitted with three antennae which are orientated orthogonally relative to each other so that the detection of a signal from the base station is independent of position. During the data return transmission from the transponder 2.2 back to the base station 3, of the three orthogonally orientated antennae, the one which has detected the highest field strength during the reception of the signal from the base station can then automatically be used. This 3D characteristic of the active transponder makes it therefore essentially insensitive relative to positional changes (rotation, tilting, etc.).

Also the transponder 2.2 itself, dependent upon the signal strength of a signal received from the base station 3, can estimate or calculate the distance from the base station 1 in order to initiate distance-dependent measures.

The transponder can have emergency operation properties. If for instance an actually active transponder has a fault or exhaustion of its energy supply, it can continue to function—admittedly with a reduced range—, in that in the sense of a passive transponder, it obtains the energy required for its own subsequent transmission process from the received electromagnetic signal. Technologies of this type are well known per se from the state of the art and are not intended to be further explained in the present case.

In addition, it is also possible that the transponder 2.2 estimates the distance from the base station on the basis of the signal strength and transmits a corresponding “standard signal” back to the base station. This “standard signal” can be combined if necessary with the identification signal with respect to the objects or containers assigned to the transponder.

Alternatively and/or additionally, the communications and indication device 2 on the FOUP 1 can also contain operating elements 2.3 in order to begin processes triggered by the operator. Included therein there are reading-out and simultaneous indication of the transponder data on the display 2.1. Furthermore, via the operating elements 2.3, the actualisation of the transponder data can be begun via the next closest base station and the network situated therebehind. It is thereby possible to transmit also instructions for the operator in addition to the transponder data, which instructions can be indicated then on the display 2.1 on the FOUP 1.

Alternatively and/or additionally, the precise position data of the FOUP 1 can be determined in the communications and indication device 2 by means of a positioning system, such as for example GPS, and be transmitted subsequently with the transponder data to the base station. The base station transmits the position data for further processing via the connected network to the central control computer.

Alternatively and/or additionally, the base stations 3 and communications and indication devices 2 for directing the FOUPs 1 through the individual process steps can be used outwith the automated transport. system of the factory. In order to control and optimise the production cycle, a central factory control checks and controls the utilisation of the individual machines and the path of the individual producer goods through the process cycle by means of an automated transport system. Sometimes, the FOUPs are redirected by means of the transport system to an alternative machine. If the FOUP 1 has however already left the transport system because it is en route to or already at a defective machine, the central factory control has no direct possibility of redirecting the FOUP to an alternative machine. The possibility exists here that the central factory control transmits instructions to the operator via the network of base stations which can be indicated subsequently on the display 2.1 of the communications and indication device 2 on the FOUP 1.

1. Method for access control in factories, having the following steps:
definition of access-controlled areas in a factory into which defined objects are not intended to enter,
attachment of a transponder to a container, the transponder carrying information with respect to the contents of the container,
provision of base stations in the access-controlled areas and,
detection by the base station if a container is approaching an access-controlled area into which the contents of the container are not intended to enter, and
indication of the non-permitted approach of a container.

2. Method according to claim 1, characterised in that
the access-controlled area is a machine to which containers are supplied.

3. Method according to one of the preceding claims, characterised by the following steps:
detection of an identification signal of a base station by a transponder attached to a container,
on the basis of the identification signal, detection by a transponder that the associated container is approaching a non-permitted area, and
indication of a warning signal on the container.

4. Method according to one of the claims 1 to 3, characterised by the following steps:
detection of an activation signal of a base station by a transponder attached to a container,
transmission of an identification from the activated transponder to the base station, and
emission of a warning signal at the base station if the identification indicates a container which is non-permitted for the area associated with the base station.

5. Method according to one of the preceding claims, characterised in that
the transponder and/or the base station determine the distance between them by means of the strength of a transmitted signal.

6. Method according to claim 5, characterised in that
different measures are adopted dependent upon the determined distance.

7. Method according to claim 4, characterised in that
respectively different frequencies are used for the signal transmission from the base station to the transponder or vice versa.

8. Method according to one of the preceding claims, characterised in that,
the base station actualises data stored in the transponder in a wireless manner.

9. Method according to one of the preceding claims, characterised in that
data stored in the transponder are indicated directly on the associated container.

10. Method according to one of the preceding claims, characterised in that
the transponder has at least two antennae which are orientated orthogonally relative to each other, that antenna which detected the highest signal strength during a previous reception of a signal being used for a transmission.

11. Method according to one of the preceding claims, characterised in that
an active transponder with passive emergency operation properties is used.

12. Method according to one of the preceding claims, characterised in that
the container is a FOUP.

13. Method according to one of the preceding claims, characterised in that
the base stations are connected to a central control system which implements the processing of the transponder data and the localisation of the containers.

14. Method according to one of the preceding claims, characterised in that
the transponder is connected via the base stations to the central control system and is suitable for transmitting data to the central control system and for indicating data, received from the central control system, on the container by means of a display.

15. Method according to one of the preceding claims, characterised in that,
due to the operating elements attached to the container, read-out, display and transmission processes can be started.

16. Device for implementation of a method according to one of the preceding claims, having the following components:
transponder attached to the containers,
base stations which are able to transmit signals to the transponder and to receive signals from the transponder, and
a central control system which networks with the base stations and is suitable for processing the data received from the base stations.

17. Use of a method according to one of the claims 1 to 12 for controlling the movement of containers in semiconductor production.
